(19) United States
(12) Patent Application Publication
(10) Pub. No.: US 2003/0069340 A1
(43) Pub. Date: Apr. 10, 2003

(54) Thermoplastic poly (hydroxy amino ether) binder

(76) Inventors: John M. Beckerdite, Lake Jackson, TX (US); Guang-Ming Xia, Lake Jackson, TX (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 09/944,526

(22) Filed: Aug. 31, 2001

(51) Int. Cl. C08K 5/09

(52) U.S. Cl. 524/284

(57) ABSTRACT

A thermoplastic binder composition comprising an aqueous solution of a poly(hydroxy amino ether) in a mono-functional acid.

### BACKGROUND OF THE INVENTION

The present invention relates to articles containing fibers bonded with binders and to the process for recovering the binder and the fibers from such articles.

Many products containing fibers such as wipers, are cured with a thermosetting latex to provide strength. Typically, 5-15% of the product run is scrap. Since the article has been cured with a thermosetting material, the scrap has no value, because the latex and fibers can not be recovered.

It would be desirable to provide a binder composition for preparing an article comprising fibers bonded with a binder which allows for the recovery of both the binder and the fibers. The inventors have found that the poly(hydroxy amino ether) binder can be recovered from fibers bonded with the binder if the binder is prepared with a mono-functional acid, but not if the binder is prepared with a multi-functional acid.

### SUMMARY OF THE INVENTION

In a first aspect, the present invention is a binder composition comprising an aqueous solution of a poly(hydroxy amino ether) (PHAE) in a mono-functional acid. In a second aspect, the present invention is an article comprising fibers bonded together with the binder composition of the first aspect.

In a third aspect, the present invention is a process for recovering the binder and fibers from the article of the second aspect which comprises contacting the article with an aqueous acetic acid solution to dissolve the binder, and then separating and recovering the binder from the acid-binder mixture.

### DETAILED DESCRIPTION OF THE INVENTION

Preferably, the binder comprises a poly(hydroxy amino ether) having repeating units represented by the formula:

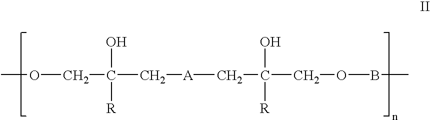

wherein R is alkyl or hydrogen; A is a diamino moiety or a combination of different amine moieties; B is a divalent organic moiety which is predominantly hydrocarbylene; and n is an integer from 5 to 1000.

The term “predominantly hydrocarbylene” means a divalent radical which is predominantly hydrocarbon, but which optionally contains a minor amount of heteroatomic moiety such as oxygen, sulfur, imino, sulfonyl, and sulfoxyl.

In the preferred embodiment of the present invention, R is hydrogen; and A is 2-hydroxyethylimino, 2-hydroxypropylimino, piperazenyl or N,N′-bis(2-hydroxyethyl)-1,2-ethylenediimino.

The polyetheramines are prepared by contacting one or more of the diglycidyl ethers of a dihydric phenol with a difunctional amine (an amine having two amine hydrogens) under conditions sufficient to cause the amine moieties to react with epoxy moieties to form a polymer backbone having amine linkages, ether linkages and pendant hydroxyl moieties. These polyetheramines are described in U.S. Pat. No. 5,275,853, incorporated herein by reference. The polyetheramines can also be prepared by contacting a diglycidyl ether or an epihalohydrin with a difunctional amine.

The PHAE is employed in an amount sufficient to bind the fibers together so that the bonded fibers exhibit structural integrity. Preferably, the amount of PHAE employed is from 0.01 to 20 weight percent based on the total weight of fibers and PHAE employed. More preferably, the amount of PHAE employed ranges from 0.1 to 10 weight percent, and most preferably is from 0.25 to 2 weight percent.

The fibers employed in the preparation of the composition of the invention can be essentially any fibers suitable for the preparation of nonwoven fabrics. Fibers useful in the preparation of nonwoven fabrics are well known. The following types of fibers are some examples of types known in the art: fibers prepared using more than one polymer, including bicomponent fibers (e.g. U.S. Pat. Nos. 5,843,063; 5,169,580; 4,634,739; 5,921,973; 4,483,976; and 5,403,444); wettable binder fibers (U.S. Pat. No. 6,218,009); hydrophilic fibers, superabsorbent polymer fibers (U.S. Pat. Nos. 5,593,399 and 5,698,480); and the fibers listed in U.S. Pat. No. 4,176,108. Mixtures of fibers can be employed. Examples of common materials used in the manufacture of fibers include natural and synthetic materials such as, for example, polyethylene, polypropylene, polyurethane, nylon, rayon, and cotton and other cellulosic materials.

Various additives may be incorporated into the composition of the invention in order to modify certain properties thereof. Examples of additives include catalysts, plasticizers, wetting agents, colorants, and other materials. (See U.S. Pat. No. 5,244,695).

In general, the poly(hydroxy amino ether) (PHAE) binder can be prepared by providing an aqueous solution of a mono-functional acid and then dissolving the PHAE in the acid solution.

The PHAE binder can be used in bonding fibers together, such as, for example, in the manufacture of nonwoven fabrics.

In general the PHAE binder can be recovered from the bonded fibers by contacting the bonded fibers with an aqueous solution of an acid to dissolve the PHAE binder and then recovering the binder from the acid-binder mixture by conventional methods. For example, the mixture containing the PHAE binder as a precipitate can be filtered to remove the solid polymer. The solid polymer can then be rinsed with water, methanol and ether or other solvents which are non-solvents for the polymer.

Acids which can be employed in the present invention for recovering the binder includes acetic acid, propanoic acid, butanoic acid, glycolic acid, lactic acid, dilute (aqueous) hydrochloric acid and phosphoric acid.

The following examples are given to illustrate the invention and should not be construed as limiting its scope. All parts and percentages are by weight unless otherwise indicated.

### EXAMPLE 1

Bleached staple cotton fiber was dried at 200° C. for 30 min. Approximately 20 g of the dried cotton fiber was accurately weighed and coated with 100 grams of 5% hydroxy functionalized poly (amino ether) resin in aqueous glycolic acid, a mono-functional acid. The coated cotton fiber was put in an oven heated to 140° C. for 30 minutes. The cotton fiber was cooled down to ambient temperature and weighed. The resin was removed by immersing the coated cotton fiber in 700 grams of 20% aqueous acetic acid solution. The acetic acid solution containing the cotton fiber was shaken overnight and thoroughly rinsed with water. The rinsed cotton fiber was dried at 200° C. for an hour, followed by 4 hours at 150° C. in a vacuum oven and the weight of the dried cotton fiber was recorded. Extraction of untreated cotton fiber with 20% aqueous acetic acid solution resulted in an average weight loss of 2% of the original fiber weight. This correction was applied to the original fiber weights. The results are shown in Table I.

TABLE I

| | Sample 1 | Sample 2 | Sample 3 |
|---|---|---|---|
| Original weight of the untreated | 20.0 g | 19.9 g | 20.0 g |
| cotton fiber | | | |
| Correction for weight loss in | 19.6 g | 19.6 g | 19.6 g |
| untreated | | | |
| fiber (2% weight loss in acetic acid) | | | |
| Weight of the cotton after being | 26.1 | 25.8 | 26.0 |
| treated and dried | | | |
| Weight of the cotton after being | 19.7 g | 19.6 g | 19.7 g |
| treated with 20% acetic acid, | | | |
| rinsed and dried | | | |
| Hydroxy functionalized poly (amino | 98% | 100% | 98% |
| ether) resin removed | | | |

The data in Table I demonstrate that the PHAE binder can be removed from the bonded fibers if the binder is prepared using a mono-functional acid, such as glycolic acid.

### EXAMPLE 2

Bleached staple cotton fiber was dried at 200° C. for 30 min. Approximately 20 g of the dried cotton fiber was accurately weighed and coated with approximately 20 g of 2.5% hydroxy functionalized poly (amino ether) resin in 2% aqueous malic acid, a non-volatile multi-functional acid. The coated cotton fiber was put in an oven heated to 140° C. for 30 min. The cotton fiber was cooled down to ambient temperature and weighed. The resin was removed by immersing the coated cotton fiber in 1400 grams of 20% aqueous acetic acid solution. The acetic acid solution containing the cotton fiber was shaken overnight and thoroughly rinsed with water. The rinsed cotton fiber was dried at 200° C. for an hour followed by 4 hours at 150° C. in a vacuum oven and the weight of the dried cotton fiber was recorded. The results are shown in Table II.

TABLE II

| | Sample 1 | Sample 2 | Sample 3 |
|---|---|---|---|
| Original weight of the cotton fiber | 20.0 g | 20.0 g | 20.0 g |
| Correction for weight loss in | 19.6 g | 19.6 g | 19.6 g |
| untreated | | | |
| fiber (2% weight loss in acetic acid) | | | |
| Weight of the cotton after being | 21.0 g | 20.9 g | 21.0 g |
| treated and dried | | | |
| Weight of the cotton after being | 20.6 g | 20.7 g | 20.6 g |
| treated with 20% acetic acid, | | | |
| rinsed and dried | | | |
| Hydroxy functionalized poly | 29% | 15% | 29% |
| (amino ether) resin/malic | | | |
| acid removed | | | |

The data in Table II demonstrate that the PHAE binder can not be removed from the bonded fibers if the binder is prepared by using a multi-functional acid, such as malic acid.

Although the invention is specifically described with respect to poly(hydroxy amino ethers) (PHAE), the present invention also encompasses other hydroxy-functionalized polyethers, such as those described in U.S. Pat. No. 5,171,820, incorporated herein by reference.

What is claimed is:

1. A thermoplastic binder composition comprising an aqueous solution of a poly(hydroxy amino ether) in a mono-functional acid.

2. The composition of claim 1 wherein the mono-functional acid is propanoic acid, butanoic acid, glycolic acid, lactic acid, hydrochloric acid and phosphoric acid.

3. An article comprising fibers bonded together with a binder composition comprising an aqueous solution of a poly(hydroxy amino ether) in a mono-functional acid.

4. The article of claim 3 wherein the poly(hydroxy amino ether) is employed in an amount sufficient to bind the fibers together so that the bonded fibers exhibit structural integrity.

5. The article of claim 4 wherein the poly(hydroxy amino ether) is employed in an amount of from 0.01 to 20 weight percent based on the total weight of fibers and poly(hydroxy amino ether) employed.

6. The article of claim 5 wherein the poly(hydroxy amino ether) is employed in an amount of from 0.1 to 10 weight percent, based on the total weight of fibers and poly(hydroxy amino ether) employed.

7. A process for recovering the binder and fibers from articles comprising fibers bonded with an aqueous solution of a poly(hydroxy amino ether) in a mono-functional acid which comprises contacting the bonded fibers with an aqueous acid solution to dissolve the poly(hydroxy amino ether) and then separating and recovering the PHAE from the acid-PHAE mixture.

8. The process of claim 7 wherein the acid is propanoic acid, butanoic acid, glycolic acid, lactic acid, hydrochloric acid or phosphoric acid.

9. A thermoplastic binder composition comprising an aqueous solution of a poly(hydroxy ether) in a mono-functional acid.

10. The composition of claim 9 wherein the mono-functional acid is propanoic acid, butanoic acid, glycolic acid, lactic acid, hydrochloric acid or phosphoric acid.

11. An article comprising fibers bonded together with a binder composition comprising an aqueous solution of a poly(hydroxy ether) in a mono-functional acid.

12. The article of claim 11 wherein the poly(hydroxy amino ether) is employed in an amount sufficient to bind the fibers together so that the bonded fibers exhibit structural integrity.

13. The article of claim 12 wherein the poly(hydroxy amino ether) is employed in an amount of from 0.01 to 20 weight percent based on the total weight of fibers and poly(hydroxy amino ether) employed.

14. The article of claim 13 wherein the poly(hydroxy amino ether) is employed in an amount of from 0.1 to 10 weight percent, based on the total weight of fibers and poly(hydroxy amino ether) employed.

15. A process for recovering the binder and fibers from articles comprising fibers bonded with an aqueous solution of a poly(hydroxy ether) in a mono-functional acid which comprises contacting the bonded fibers with an aqueous acid solution to dissolve the poly(hydroxy amino ether) and then separating and recovering the PHAE from the acid-PHAE mixture.

16. The process of claim 15 wherein the acid is propanoic acid, butanoic acid, glycolic acid, lactic acid, hydrochloric acid or phosphoric acid.
